(19) United States
(12) Patent Application Publication
(10) Pub. No.: US 2025/0254517 A1
(43) Pub. Date: Aug. 7, 2025

(54) USER EQUIPMENT, ELECTRONIC DEVICE, WIRELESS COMMUNICATION METHOD, AND STORAGE MEDIUM

(71) Applicant: Sony Group Corporation, Tokyo (JP)

(72) Inventors: Hui LI, Beijing (CN); Kai MA, Beijing (CN); Junchi ZENG, Beijing (CN); Chi MA, Beijing (CN); Xiaoxue WANG, Beijing (CN); Chen SUN, Beijing (CN)

(73) Assignee: Sony Group Corporation, Tokyo (JP)

(21) Appl. No.: 18/856,072

(22) PCT Filed: Apr. 14, 2023
(86) PCT No.: PCT/CN2023/088262

§ 371 Date: Oct. 11, 2024

(30) Foreign Application Priority Data
Apr. 22, 2022 (CN) 202210428623.3

(51) Int. Cl. H04W 12/0431; H04W 12/06; H04W 12/106; H04W 12/122

(52) U.S. Cl. CPC H04W 12/0431; H04W 12/06; H04W 12/106; H04W 12/122

(57) ABSTRACT

The present disclosure relates to a user equipment, an electronic device, a wireless communication method, and a storage medium. The user equipment according to the present disclosure comprises a processing circuit configured to: determine a physical layer key according to features of a wireless channel between the user equipment and a serving network; receive a serving network message authentication code and a home network authentication token from the serving network; determine an authentication parameter according to the physical layer key and the home network authentication token; and authenticate the serving network according to the authentication parameter and the serving network message authentication code. By using the user equipment, electronic device, wireless communication method, and storage medium according to the present disclosure, an authentication process in a scenario where the user equipment roams can be optimized.

The present application claims the priority to Chinese Patent Application No. 202210428623.3, titled “USER EQUIPMENT, ELECTRONIC DEVICE, WIRELESS COMMUNICATION METHOD, AND STORAGE MEDIUM”, filed on Apr. 22, 2022 with the China National Intellectual Property Administration, which is incorporated herein by reference in its entirety.

### FIELD

The present disclosure generally relates to the field of wireless communications, and in particular to user equipment, an electronic device, a wireless communication method and a computer-readable storage medium. More specifically, the present disclosure relates to user equipment in a wireless communication system, an electronic device in a core network of a Home Network (HN) in a wireless communication system, an electronic device in a core network of a Serving Network (SN) in a wireless communication system, a wireless communication method performed by user equipment in a wireless communication system, a wireless communication method performed by an electronic device in a core network of a home network in a wireless communication system, a wireless communication method performed by an electronic device in a core network of a serving network in a wireless communication system, and a computer-readable storage medium.

### BACKGROUND

User equipment may be located outside a service range of a HN during roaming, and thus the SN may provide services for the user equipment.

In a scenario of roaming as described above, the user equipment may authenticate the SN in an implicit manner according to the existing standards. That is, if a negotiated key may be successfully used in a process after the authentication, it is considered that the SN has been authenticated by the user equipment. This means that the network security largely depends on the confirmation of the key in the subsequent process, which may easily leads to security risks.

Furthermore, in the scenario of roaming as described above, an SQN mechanism is adopted in order to synchronize the user equipment and the HN according to the existing standards, that is, both the user equipment and the HN save an SQN (SeQuence Number). In this case, if the synchronization of the SQN is lost between the user equipment and the HN, an attacker may perform a replay attack. Specifically, the attacker may capture a legitimate authentication request message in advance, which message includes a pair of messages transmitted by the network to the victim. If the attacker wants to determine a location of the victim in a specific area, the attacker may replay the captured authentication request message. On receipt of the replayed authentication token and the authentication request message, the victim may transmit a synchronization failure message, while other user equipment may transmit MAC (Message Authentication Code) authentication failure message. In this way, the attacker may determine whether the victim exists in the specific area based on differences between the returned messages, which violates unlinkability and location confidentiality of user equipment.

Therefore, it is required to provide a technical solution to optimize an authentication process in a scenario where user equipment is roaming.

### SUMMARY

This section provides a general summary of the present disclosure, rather than a comprehensive disclosure of its full scope or its features.

An object of the present disclosure is to provide user equipment, an electronic device, a wireless communication method, and a computer-readable storage medium, to optimize the authentication process in the scenario where user equipment is roaming.

According to an aspect of the present disclosure, user equipment is provided. The user equipment includes processing circuitry which is configured to determine a physical layer key according to wireless channel characteristics between the user equipment and a serving network; receive a serving network message authentication code and a home network authentication token from the serving network; determine an authentication parameter according to the physical layer key and the home network authentication token; and authenticate the serving network according to the authentication parameter and the serving network message authentication code.

According to another aspect of the present disclosure, an electronic device in a serving network is provided. The electronic device includes processing circuitry which is configured to receive a home network authentication token from a home network; determine a serving network message authentication code according to a physical layer key determined from wireless channel characteristics between user equipment and the serving network; and transmit the serving network message authentication code and the home network authentication token to the user equipment, for the user equipment to determine an authentication parameter according to the physical layer key and the home network authentication token, and to authenticate the serving network according to the authentication parameter and the serving network message authentication code.

According to another aspect of the present disclosure, an electronic device in a home network is provided. The electronic device includes processing circuitry which is configured to generate a second random number; determine a home network authentication token according to a long-term key between the electronic device and user equipment and the second random number; and transmit the home network authentication token and the second random number to a serving network, for the serving network to determine a serving network message authentication code according to the second random number, and to transmit the serving network message authentication code and the home network authentication token to the user equipment.

According to another aspect of the present disclosure, a wireless communication method performed by user equipment is provided. The wireless communication method includes determining a physical layer key according to wireless channel characteristics between the user equipment and a serving network; receiving a serving network message authentication code and a home network authentication token from the serving network; determining an authentication parameter according to the physical layer key and the home network authentication token; and authenticating the serving network according to the authentication parameter and the serving network message authentication code.

According to another aspect of the present disclosure, a wireless communication method performed by an electronic device in a serving network is provided. The wireless communication method includes receiving a home network authentication token from a home network; determining a serving network message authentication code according to a physical layer key determined from wireless channel characteristics between user equipment and the serving network; and transmitting the serving network message authentication code and the home network authentication token to the user equipment, for the user equipment to determine an authentication parameter according to the physical layer key and the home network authentication token, and to authenticate the serving network according to the authentication parameter and the serving network message authentication code.

According to another aspect of the present disclosure, a wireless communication method performed by an electronic device in a home network is provided. The wireless communication method includes generating a second random number; determining a home network authentication token according to a long-term key between the electronic device and user equipment and the second random number; and transmitting the home network authentication token and the second random number to a serving network, for the serving network to determine a serving network message authentication code according to the second random number, and to transmit the serving network message authentication code and the home network authentication token to the user equipment.

According to another aspect of the present disclosure, a computer-readable storage medium including executable computer instructions is provided. The executable computer instructions, when being executed by a computer, cause the computer to perform the wireless communication method according to the present disclosure.

According to another aspect of the present disclosure, a computer program is provided. The computer program, when executed by a computer, causes the computer to execute the wireless communication method according to the present disclosure.

With the user equipment, the electronic device, the wireless communication method, and the computer-readable storage medium according to the present disclosure, the user equipment may authenticate the SN according to the authentication parameter and the serving network message authentication code. That is, the user equipment may authenticate the SN in an explicit manner. Compared with the implicit authentication, the explicit authentication can improve network security. Furthermore, the user equipment authenticates the SN by using the physical layer key. Since the physical layer key is generated according to the wireless channel characteristics between the user equipment and the SN, it is cannot be replicated by the attacker. That is, the attacker cannot forge an identity of the SN to deceive the user equipment. Therefore, the network security is improved. In addition, the electronic device in the HN determines the home network authentication token according to the second random number, so that the user equipment can restore the second random number from the home network authentication token, generate the authentication parameter according to the restored second random number, and authenticate the SN according to the authentication parameter and the serving network message authentication code. As such, HN and the user equipment are not required to save the SQN, thereby avoiding the replay attack due to the loss of synchronization of SQN. In summary, with the user equipment, the electronic device, the wireless communication method, and the computer-readable storage medium according to the present disclosure, the authentication process in the scenario where the user equipment is roaming can be optimized, thereby improving the network security.

A further applicable field becomes apparent from the description herein. The descriptions and specific examples in this summary are only illustrative and are not intended to limit the scope of the present disclosure.

### BRIEF DESCRIPTION OF THE DRAWINGS

The drawings are only used for illustrating the selected embodiments rather than all possible implementations, and are not intended to limit the scope of the present disclosure. In the drawings:

FIG. 1 is a schematic diagram illustrating an overall network architecture in case of user equipment in a roaming scenario according to an embodiment of the present disclosure;

FIG. 2 is a block diagram illustrating an example of a configuration of user equipment according to an embodiment of the present disclosure;

FIG. 3 is a block diagram illustrating an example of a configuration of an electronic device in a serving network according to an embodiment of the present disclosure;

FIG. 4 is a block diagram illustrating an example of a configuration of an electronic device in a home network according to an embodiment of the present disclosure;

FIG. 5 is a signaling flowchart illustrating an initialization process of an authentication method according to an embodiment of the present disclosure;

FIG. 6 is a signaling flowchart illustrating an authentication process of an authentication method according to an embodiment of the present disclosure;

FIG. 7 is a flowchart of a wireless communication method performed by user equipment according to an embodiment of the present disclosure;

FIG. 8 is a flowchart illustrating a wireless communication method performed by electronic equipment in SN according to an embodiment of the present disclosure.

FIG. 9 is a flowchart illustrating a wireless communication method performed by an electronic device according to an embodiment of the present disclosure;

FIG. 10 is a block diagram illustrating an example of a server that can implement an electronic device according to an embodiment of the present disclosure.

FIG. 11 is a block diagram illustrating an example of a schematic configuration of a smartphone; and

FIG. 12 is a block diagram illustrating an example of a schematic configuration of a car navigation apparatus.

Although various modification and alternations are easily made onto the present disclosure, the specific embodiments are shown in the drawings as an example, and are described in detail here. It should be understood that description of the specific embodiments is not intended to limit the present disclosure to the disclosed specific forms, but instead the present disclosure intends to cover all modifications, equivalents and alternations that fall within the spirit and scope of the present disclosure. It should be noted that a component is indicated by a corresponding reference sign throughout the drawings.

### DETAILED DESCRIPTION OF EMBODIMENTS

Examples of the present disclosure are fully disclosed with reference to the drawings. The following description is merely exemplary and is not intended to limit the present disclosure and an application or use thereof.

Exemplary embodiments are provided, so that the present disclosure becomes thorough and fully convey the scope thereof to those skilled in the art. Examples of specific components, apparatus, methods and other specific details are set forth to provide a thorough understanding of embodiments of the present disclosure. It will be apparent to those skilled in the art that exemplary embodiments may be implemented in many different forms without the use of specific details, and they should not be construed as limiting the scope of the present disclosure. In some exemplary embodiments, well-known processes, structures and technologies are not described in detail.

Description is made in the following order:
1. Description of scenarios;
2. Configuration examples of user equipment;
3. Configuration examples of electronic device in serving network;
4. Configuration examples of electronic device in home network;
5. Signaling flowchart;
6. Embodiments of method; and
7. Application examples.

### 1. Description of Scenarios

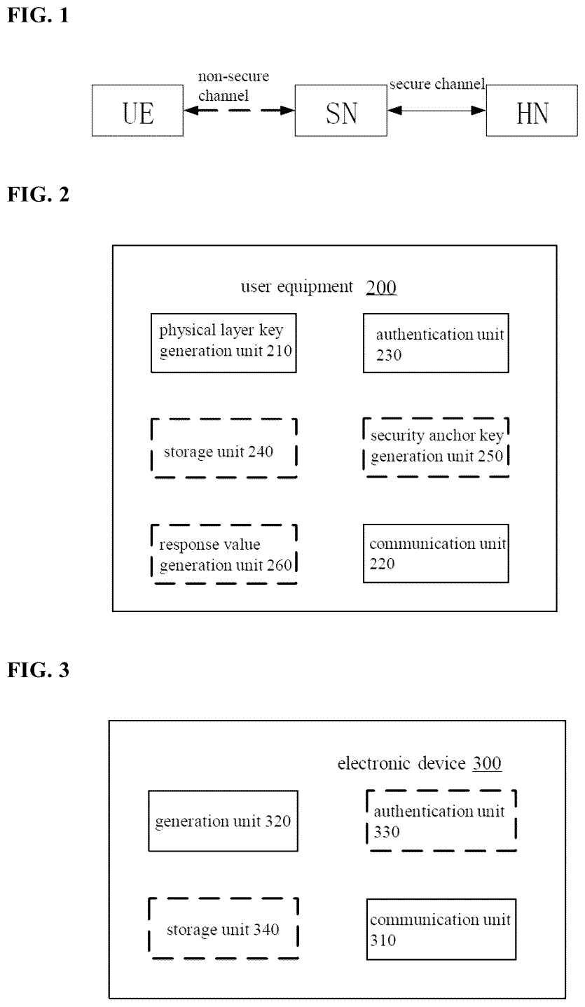

FIG. 1 is a schematic diagram illustrating an overall network architecture in a scenario where user equipment is roaming according to an embodiment of the present disclosure. As shown in FIG. 1, UE (User Equipment) roams to the outside of a service range of a HN, and an SN provides services to the UE. The UE communicates with the SN via a wireless channel, and thus it is considered that the channel between the UE and the SN is insecure and is possibly attacked by an attacker. The SN communicates with the HN via an authenticated channel, and thus it is considered that the channel between the SN and the HN is secure.

Furthermore, in FIG. 1, a USIM (Universal subscriber identity module) of the UE may store an SUPI (SUbscription Permanent Identifier), and the HN may also store the SUPI of the UE. In order to prevent leakage of the SUPI in the wireless channel, only an SUCI (SUbscription Concealed Identifier) generated by encrypting the SUPI is transmitted. In addition, the UE and the HN may share a long-term key K of the UE.

For a scenario where user equipment is roaming, user equipment and an electronic device in a wireless communication system, a wireless communication method performed by user equipment in a wireless communication system, a wireless communication method performed by an electronic device in a wireless communication system and a computer-readable storage medium are provided according to the present disclosure, to optimize an authentication process in the scenario where user equipment is roaming.

The wireless communication system according to the present disclosure may be a 5G NR communication system. In addition, as the technology develops, the wireless communication system according to the present disclosure may be a 6G or next-generation communication system. The wireless communication system according to the present disclosure may include user equipment, a serving network and a home network.

According to the present disclosure, an electronic device for the serving network and an electronic device for the home network may be located in a core network of the serving network and a core network of the home network, respectively, and may be implemented as any type of servers, such as tower server, rack server or blade server. The electronic device may be a control module (such as an integrated circuitry module including a single die, and a card or blade inserted into a slot of a blade server) mounted on the server.

Furthermore, the serving network may include a RAN (Radio Access Network) and an AMF (Access and Mobility Management Function)/SEAF (SEcurity Anchor Function) network element. The RAN may include a base station device such as gNB, and the AMF/SEAF network element may be located in the core network of the serving network. That is, the electronic device for the serving network according to the present disclosure may be the AMF and/or SEAF network element in the core network of the serving network.

The user equipment according to the present disclosure may be a mobile terminal (such as smartphone, tablet personal computer (PC), notebook PC, portable game terminal, portable/dongle type mobile router and digital camera) or a vehicle-mounted terminal (such as car navigation apparatus). The user equipment may also be implemented as a terminal (also referred to as machine-type communication (MTC) terminal) that performs machine-to-machine (M2M) communication. Furthermore, the user equipment may be a wireless communication module (such as an integrated circuitry module including a single die) mounted on each of the terminals described above.

### 2. Configuration Examples of User Equipment

FIG. 2 is a block diagram illustrating an example of a configuration of user equipment 200 according to an embodiment of the present disclosure.

As shown in FIG. 2, the user equipment 200 may include a physical layer key generation unit 210, a communication unit 220, and an authentication unit 230.

Here, each unit of the user equipment 200 may be included in processing circuitry. It should be noted that the user equipment 200 may include one or more processing circuitry. Furthermore, the processing circuitry may include various discrete functional units to perform various functions and/or operations. It should be noted that these functional units may be physical entities or logical entities, and units with different names may be implemented by the same physical entity.

According to the embodiment of the present disclosure, the physical layer key generation unit 210 may determine a physical layer key Kp according to wireless channel characteristics between the user equipment 200 and a serving network.

According to the embodiment of the present disclosure, the user equipment 200 may receive an SNMAC (Serving Network Message Authentication Code) and a home network AUTN (Authentication TokeN) from the serving network via the communication unit 220.

According to the embodiment of the present disclosure, the authentication unit 230 may determine an authentication parameter (which may also be referred to as a first authentication parameter in order to distinguish from a second authentication parameter and a third authentication parameter described below) according to the Kp and the home network AUTN, and authenticate the SN according to the authentication parameter and the SNMAC.

It can be seen that the user equipment 200 according to the embodiment of the present disclosure may authenticate the SN according to the authentication parameter and the SNMAC. That is, the user equipment 200 may authenticate the SN in an explicit manner. Compared with the implicit authentication, the explicit authentication can improve the network security. Furthermore, the user equipment 200 may authenticate the SN by using the Kp. Since the Kp is generated according to the wireless channel characteristics between the user equipment 200 and the SN, an attacker cannot replicate the Kp, that is, the attacker cannot forge an identity of the SN to deceive the user equipment 200. As such, the network security is improved. In summary, according to the present disclosure, the authentication process in a scenario where the user equipment 200 is roaming can be optimized, thereby improving the network security.

According to the embodiment of the present disclosure, the user equipment 200 and a base station device in the SN may transmit reference signals to each other to estimate a channel between the user equipment 200 and the base station device, so that the physical layer key generation unit 210 can determine the physical layer key Kp according to the wireless channel characteristics. The wireless channel characteristics include but are not limited to RSS (Received Signal Strength) and CSI (Channel State Information).

According to the embodiment of the present disclosure, as shown in FIG. 2, the user equipment 200 may further include a storage unit 240 for storing the long-term key K and the physical layer key Kp of the user equipment 200.

According to the embodiment of the present disclosure, the physical layer key generation unit 210 may determine the physical layer key Kp according to the wireless channel characteristics using any methods known in the art, which is not limited in the present disclosure. For example, the physical layer key generation unit 210 may generate the physical layer key Kp in four steps of channel measurement, quantization, information reconciliation and privacy amplification.

According to the embodiment of the present disclosure, after the user equipment 200 and the base station device in the SN determine the physical layer key Kp of the user equipment 200, the base station device in the SN may transmit the physical layer key Kp to the core network in the SN, such as the AMF/SEAF network element in the core network. Specifically, after the physical layer key generation unit 210 generates the physical layer key Kp, the user equipment 200 may transmit an N1 message (i.e., an access network message) to the base station device in the SN via the communication unit 220. The N1 message includes the SUCI generated by encrypting the SUPI, an access network parameter, a message type, a security parameter or other information. Furthermore, the base station device in the SN may transmit an N2 message to the core network in the SN. The N2 message may include the SUCI and the physical layer key Kp of the user equipment 200, N2 parameters, a registration request, UE policy container or other information. In this way, the user equipment 200 can share the physical layer key Kp of the user equipment 200 with the SN.

According to the embodiment of the present disclosure, the Kp is generated according to the wireless channel characteristics between the user equipment 200 and the SN. Attackers located at other locations cannot acquire the wireless channel characteristics between the user equipment 200 and the SN, and thus cannot replicate the physical layer key Kp. In addition, every time the user equipment 200 needs to perform connection authentication, the physical layer key generation unit 210 may generate the physical layer key Kp. That is, the physical layer key Kp used for each authentication is different. Based on this, the user equipment 200 can determine whether a message is replayed, thereby eliminating the threat of replay attack.

According to the embodiment of the present disclosure, the authentication unit 230 may determine a second random number R2 generated by the home network according to the home network AUTN.

Specifically, the authentication unit 230 may determine a hidden value CONC of the second random number R2 according to the home network AUTN. Here, the home network AUTN includes values of CONC and HNMAC (Home Network Message Authentication Code), and thus the authentication unit 230 may decompose CONC and HNMAC from the home network AUTN. That is, the authentication unit 230 may determine the CONC by the equation (1):

$$AUTN {\to }^{decomposite} CONC , MNMAC \qquad ( 1 )$$

According to the embodiment of the present disclosure, the authentication unit 230 may further determine the anonymous key AK according to the long-term key K between the user equipment 200 and the HN. Here, the authentication unit 230 may acquire the value of long-term key K from the storage unit 240. Furthermore, the user equipment 200 may receive, from the SN via the communication unit 220, the first random number R1 generated by the HN, so that the authentication unit 230 can determine the anonymous key AK according to the first random number R1 and the long-term key K. Specifically, the authentication unit 230 may determine the anonymous key AK according to a functional relationship fs between the anonymous key AK, the first random number R1 and the long-term key K. That is, the authentication unit 230 may determine the anonymous key AK by the equation (2):

$$AK = {f}_{5} ( K , R 1 ) \qquad ( 2 )$$

According to the embodiment of the present disclosure, the authentication unit 230 may determine the second random number R2 according to the anonymous key AK and the hidden value CONC of the second random number. Specifically, the authentication unit 230 may determine the R2 by performing XOR operation on the AK and the CONC. That is, the authentication unit 230 may determine the R2 by the equation (3):

$$R 2 = AK ⊕ CONC \qquad ( 3 )$$

According to the embodiment of the present disclosure, the authentication unit 230 may determine a value of an authentication parameter XSNMAC according to the physical layer key Kp and the second random number R2. The authentication parameter may represent an expected serving network message authentication code. For example, the authentication unit 230 may determine the authentication parameter XSNMAC according to a functional relationship f1 between the authentication parameter XSNMAC, the physical layer key Kp and the second random number R2. That is, the authentication unit 230 may determine the authentication parameter XSNMAC by the equation (4):

$$XSNMAC = {f}_{1} ( Kp , R 2 ) \qquad ( 4 )$$

According to the embodiment of the present disclosure, after determining the authentication parameter XSNMAC, the authentication unit 230 may authenticate the SN according to the authentication parameter XSNMAC and the SNMAC received from the SN. For example, the authentication unit 230 may authenticate the SN by comparing the authentication parameter XSNMAC with the SNMAC received from the SN. Furthermore, in a case that the authentication parameter XSNMAC is consistent with the SNMAC, the authentication unit 230 may determine that the SN is successfully authenticated. In a case that the authentication parameter XSNMAC is inconsistent with the SNMAC, the authentication unit 230 may determine that the SN is not successfully authenticated.

It can be seen that the user equipment 200 according to the embodiment of the present disclosure may restore a value of the R2 from the home network AUTN, and generate the authentication parameter XSNMAC according to the physical layer key Kp and the R2, thereby authenticating the SN in an explicit manner according to the authentication parameter XSNMAC and the SNMAC.

According to the embodiment of the present disclosure, the authentication unit 230 may further determine the HNMAC according to the home network AUTN. For example, the authentication unit 230 may decompose the HNMAC from the home network AUTN by the equation (1).

According to the embodiment of the present disclosure, the authentication unit 230 may determine a second authentication parameter according to the long-term key K between the user equipment 200 and the HN.

Specifically, the authentication unit 230 may determine the second authentication parameter XHNMAC according to the first random number R1 received from the SN and the long-term key K. The second authentication parameter XHNMAC may represent an expected home network message authentication code. For example, the authentication unit 230 may determine the second authentication parameter XHNMAC according to the functional relationship f₁ between the second authentication parameter XHNMAC, the long-term key K and the first random number R1. That is, the authentication unit 230 may determine the second authentication parameter XHNMAC by the equation (5):

$$XHNMAC = {f}_{1} ( K , R 1 ) \qquad ( 5 )$$

According to the embodiment of the present disclosure, the authentication unit 230 may authenticate the HN according to the second authentication parameter XHNMAC and the HNMAC determined from the home network AUTN. For example, the authentication unit 230 may authenticate the HN by comparing the second authentication parameter XHNMAC with the HNMAC determined from the home network AUTN. Furthermore, in a case that the second authentication parameter XHNMAC is consistent with the HNMAC, the authentication unit 230 may determine that the HN is successfully authenticated. In a case that the authentication parameter XHNMAC is inconsistent with the HNMAC, the authentication unit 230 may determine that the HN is not successfully authenticated.

It can be seen that the user equipment 200 according to the embodiment of the present disclosure may generate the second authentication parameter XHNMAC according to the long-term key K and the R1, thereby authenticating the HN according to the second authentication parameter XHNMAC and the HNMAC decomposed from the home network AUTN.

According to the embodiment of the present disclosure, as shown in FIG. 2, the user equipment 200 may further include a security anchor key generation unit 250. The security anchor key generation unit 250 is configured to generate a security anchor key K SEAF. Specifically, the security anchor key generation unit 250 may determine the security anchor key K_{SEAF} according to the first random number R1 received from the SN, the long-term key K between the user equipment 200 and the HN stored in the storage unit 240, and the identification information (SNname) of the SN. For example, the security anchor key generation unit 250 may generate the security anchor key K_{SEAF} according to the R1, K, and the identification information of the SN through KDF (Key Derivation Function). That is, the security anchor key generation unit 250 may generate the security anchor key K_{SEAF} by the equation (6):

$${K}_{SEAF} = KDF ( K , R 1 , SNname ) \qquad ( 6 )$$

According to the embodiment of the present disclosure, after the security anchor key generation unit 250 generates the security anchor key K_{SEAF}, a key for communication may be derived from the security anchor key K_{SEAF} for communication between the user equipment 200 and the SN.

It can be seen that according to the embodiment of the present disclosure, the user equipment 200 only generates the physical layer key Kp during each authentication. After the successful authentication between the user equipment 200 and the network, the user equipment 200 may communicate with the SN by using the key derived from the security anchor key K_{SEAF}. Compared with the physical layer security technology in which the physical layer key is to be generated during each communication, the present disclosure can simplify operations and reduce difficulty of implementation.

According to the embodiment of the present disclosure, as shown in FIG. 2, the user equipment 200 may further include a response value generation unit 260. The response value generation unit 260 is configured to generate a response value RES*. Specifically, the response value generation unit 260 may determine the response value RES* according to the first random number R1 received from the SN, the long-term key K between the user equipment 200 and the HN, and the identification information of the SN. For example, the response value generation unit 260 may determine the response value RES* according to the functional relationship f₂ between the response value RES* and the long-term key K, the first random number R1, and the identification information (SNname) of the SN. That is, the response value generation unit 260 may determine the response value RES* by the equation (7)

$${RES}^{*} = {f}_{2} ( K , R 1 , SNname ) \qquad ( 7 )$$

According to the embodiment of the present disclosure, the user equipment 200 may transmit the response value RES* generated by the response value generation unit 260 to the SN via the communication unit 220 for the SN to authenticate the user equipment 200. For example, the user equipment 200 may transmit, via the communication unit 220, the response value RES* generated by the response value generation unit 260 to the base station device in the SN, and the base station device in the SN forwards the response value RES* to the core network in the SN, so that the core network in the SN can authenticate the user equipment 200.

As described above, the user equipment 200 according to the embodiment of the present disclosure may authenticate the SN in an explicit manner. Compared with the implicit authentication, the explicit authentication can improve network security. Furthermore, the user equipment 200 may authenticate the SN by using the physical layer key Kp. Since the physical layer key Kp is generated according to the wireless channel characteristics between the user equipment 200 and the SN, and the physical layer key Kp is regenerated during each authentication, the attacker cannot replicate the physical layer key Kp. That is, the attacker cannot forge an identity of the SN to deceive the user equipment 200. As such, the network security is improved. In addition, after successfully authenticating the SN, the user equipment 200 communicates with the SN by using the key derived from the security anchor key, which is simpler compared with the physical layer security technology in which the physical layer key is to be generated during each communication. Furthermore, the user equipment 200 authenticates the SN by using the second random number R2 obtained from the home network AUTN, and thus the user equipment 200 is not required to save SQN, thereby avoiding the replay attack due to the loss of synchronization of the SQN. In summary, with the user equipment 200 according to the present disclosure, the authentication process in a scenario where the user equipment 200 is roaming can be optimized, thereby improving the network security.

### 3. Configuration Examples of Electronic Device in Serving Network

FIG. 3 is a block diagram illustrating an example of a configuration of an electronic device 300 according to an embodiment of the present disclosure. The electronic device 300 may be located in the SN. Specifically, the electronic device 300 may be located in the core network in the SN, such as, an AMF network element and/or SEAF network element in the core network in the SN. Since a function of the AMF network element is closely related to a function of the SEAF network element, the AMF network element and the SEAF network element are not distinguished in the present disclosure.

As shown in FIG. 3, the electronic device 300 may include a communication unit 310 and a generation unit 320.

Here, each unit of the electronic device 300 may be included in processing circuitry. It should be noted that the electronic device 300 may include one or more processing circuitry. Furthermore, the processing circuitry may include various discrete functional units to perform various functions and/or operations. It should be noted that these functional units may be physical entities or logical entities, and units with different names may be implemented by the same physical entity.

According to the embodiment of the present disclosure, the electronic device 300 may receive the home network AUTN from the HN via the communication unit 310.

According to the embodiment of the present disclosure, the generation unit 320 may determine the SNMAC according to the physical layer key Kp determined by the wireless channel characteristics between the user equipment and the SN.

According to the embodiment of the present disclosure, the electronic device 300 may transmit the SNMAC and the home network AUTN to the user equipment via the communication unit 310, for the user equipment to determine the authentication parameter according to the home network AUTN and the physical layer key Kp, and authenticate the SN according to the authentication parameter and the SNMAC.

As described above, the electronic device 300 according to the embodiment of the present disclosure may determine the SNMAC according to the physical layer key Kp, so that the user equipment may authenticate the SN according to the SNMAC and the authentication parameter generated according to the physical layer key Kp. Since the physical layer key Kp is generated according to the wireless channel characteristics between the user equipment and the SN, and the physical layer key Kp is regenerated during each authentication, the attacker cannot replicate the physical layer key Kp, that is, the attacker cannot forge an identity of the SN to deceive the user equipment, thereby improving the network security.

According to the embodiment of the present disclosure, the electronic device 300 may receive, from the base station device in the SN, the physical layer key Kp between the user equipment and the SN via the communication unit 310. Furthermore, as shown in FIG. 3, the electronic device 300 may further include a storage unit 340 for storing the physical layer key Kp between the user equipment and the SN.

According to the embodiment of the present disclosure, the electronic device 300 may further receive a second random number R2 from the HN via the communication unit 310. Furthermore, the generation unit 320 may determine the SNMAC according to the second random number R2 and the physical layer key Kp. For example, the generation unit 320 may determine the SNMAC according to the functional relationship f₁ between the SNMAC and the physical layer key Kp and the second random number R2. That is, the generation unit 320 may determine the SNMAC by the equation (8):

$$SNMAC = {f}_{1} ( Kp , R 2 ) \qquad ( 8 )$$

As described above, the electronic device 300 according to the embodiment of the present disclosure may determine the SNMAC be according to the second random number R2, so that the user equipment may acquire the authentication parameter by using the second random number R2 obtained from the home network AUTN, and authenticate the SN according to the authentication parameter and the SNMAC. In this way, the user equipment and the HN are not required to save the SQN, thereby avoiding replay attack due to the loss of synchronization of the SQN.

According to the embodiment of the present disclosure, the electronic device 300 may receive the response value RES* from the user equipment via the communication unit 310. For example, the electronic device 300 may receive, from the base station device in the SN via the communication unit 310, the response value RES* of the user equipment forwarded by the base station device. In addition, the electronic device 300 may further receive a reference value HXRES* of the response value from the HN via the communication unit 310.

According to the embodiment of the present disclosure, as shown in FIG. 3, the electronic device 300 may further include an authentication unit 330. The authentication unit 330 is configured to authenticate the user equipment. Specifically, the authentication unit 330 may determine a third authentication parameter according to the response value RES* of the user equipment.

According to the embodiment of the present disclosure, the electronic device 300 may receive the first random number R1 from the HN via the communication unit 310, and the authentication unit 330 determines the third authentication parameter according to the first random number R1 and the response value RES* of the user equipment. Specifically, the authentication unit 330 may determine the third authentication parameter by concatenating the first random number R1 and the response value RES* of the user equipment and then performing hash operation. That is, the authentication unit 330 may determine the third authentication parameter by the following equation (9):

$$third authentication parameter = Hash ( 〈 R 1 , {RES}^{*} 〉 ) \qquad ( 9 )$$

Hash represents hash function, and < > represents string concatenation operation.

According to the embodiment of the present disclosure, the authentication unit 330 may authenticate the user equipment according to the third authentication parameter and the reference value HXRES* of the response value. Here, the reference value HXRES* of the response value is a value that is generated by the HN concatenating the first random number R1 and an expected response value XRES* and then performing hash operation. The reference value HXRES* represents an expected value of the third authentication parameter. In a case that the third authentication parameter is consistent with the reference value HXRES* of the response value, the authentication unit 330 may determine that the user equipment is successfully authenticated. In a case that the third authentication parameter is inconsistent with the reference value HXRES* of the response value, the authentication unit 330 may determine that the user equipment is not successfully authenticated.

According to the embodiment of the present disclosure, in a case that the authentication unit 330 successfully authenticates the user equipment, the electronic device 300 may forward the response value RES* of the user equipment to the HN via the communication unit 310 for the HN to authenticate the user equipment.

It can be seen that the electronic device 300 according to the embodiment of the present disclosure may authenticate the user equipment by using the response value RES* of the user equipment. That is, bidirectional authentication between the user equipment and the SN can be implemented, thereby improving the network security.

According to the embodiment of the present disclosure, the electronic device 300 may further receive the security anchor key K_{SEAF} from the HN via the communication unit 310 for communication between the SN and the user equipment. Furthermore, the electronic device 300 may derive the key for communication with the user equipment by using the security anchor key K_{SEAF}.

As described above, the electronic device 300 may receive, from the HN via the communication unit 310, one or more of the following parameters: the first random number R1, the second random number R2, the home network AUTN, the reference value HXRES* of the response value, and the security anchor key K_{SEAF}. In an embodiment, the electronic device 300 may receive an authentication vector (AV) from the HN via the communication unit 310, and the authentication vector includes one or more of the above parameters.

As described above, the electronic device 300 according to the embodiment of the present disclosure may determine the SNMAC according to the physical layer key Kp and the second random number R2, the user equipment generates the authentication parameter according to the physical layer key Kp and the second random number R2 obtained from the home network AUTN and authenticates the SN according to the authentication parameter and the SNMAC. On the one hand, the physical layer key Kp is generated according to the wireless channel characteristics between the user equipment and the SN, and the physical layer key Kp is regenerated during each authentication, and therefore the attacker cannot replicate the physical layer key Kp. On the other hand, the user equipment and the HN are not required to save the SQN due to the use of the second random number R2, thereby avoiding the replay attack due to the loss of synchronization of the SQN. In addition, the electronic device 300 can implement bidirectional authentication between the user equipment and the SN, thereby improving the network security.

### 4. Configuration Examples of Electronic Device in Home Network

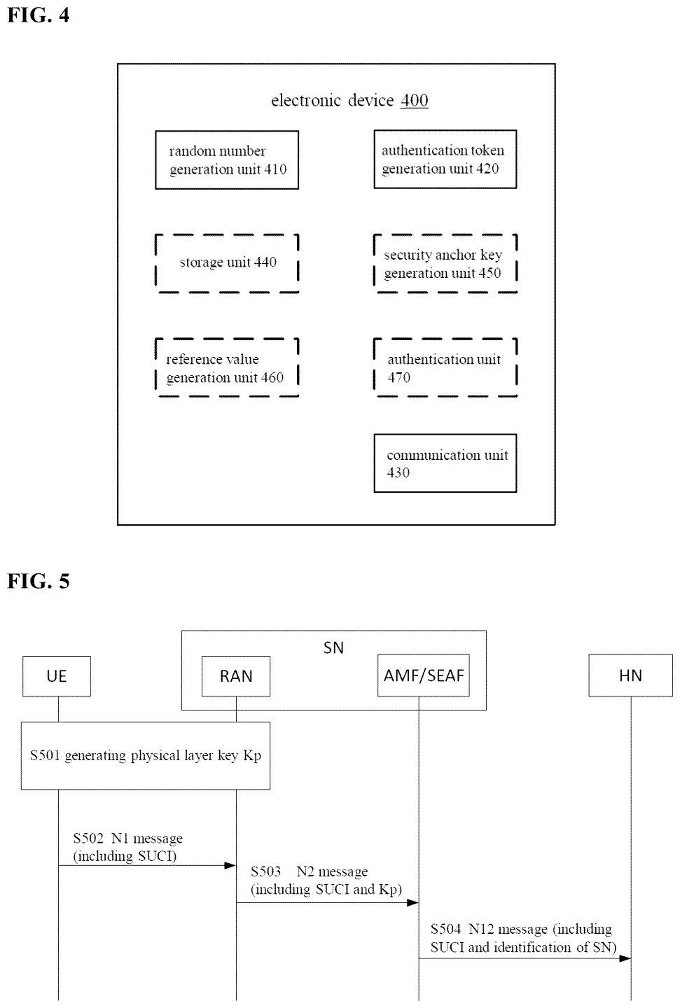

FIG. 4 is a block diagram illustrating a structure of an electronic device 400 in a home network according to an embodiment of the present disclosure. The electronic device 400 may be located in the core network of the HN.

As shown in FIG. 4, the electronic device 400 may include a random number generation unit 410, an authentication token generation unit 420 and a communication unit 430.

Here, each unit of the electronic device 400 may be included in processing circuitry. It should be noted that the electronic device 400 may include one or more processing circuitry. Furthermore, the processing circuitry may include various discrete functional units to perform various functions and/or operations. It should be noted that these functional units may be physical entities or logical entities, and units with different names may be implemented by the same physical entity.

According to the embodiment of the present disclosure, the random number generation unit 410 may generate the second random number R2. Here, the random number generation unit 410 may generate a random number by using any method known in the art, which is not limited in the present disclosure.

According to the embodiment of the present disclosure, the authentication token generation unit 420 may determine the home network AUTN according to the second random number R2 and a long-term key K between the electronic device 400 and the user equipment.

According to the embodiment of the present disclosure, the electronic device 400 may transmit the home network AUTN and the second random number R2 to the SN via the communication unit 430, for the SN to determine the SNMAC according to the second random number R2 and transmit the SNMAC and the home network AUTN to the user equipment.

As described above, the electronic device 400 according to the embodiment of the present disclosure may generate the home network AUTN by using the second random number R2, so that the user equipment can authenticate the SN by using the second random number R2 obtained from the home network AUTN. In this way, the electronic device 400 and the equipment are not required to save the SQN, and replay attack due to the loss of synchronization of the SQN can be avoided, thereby improving the network security.

According to the embodiment of the present disclosure, as shown in FIG. 4, the electronic device 400 may further include a storage unit 440 for storing the long-term key K between the user equipment and the electronic device 400.

According to the embodiment of the present disclosure, the authentication token generation unit 420 may determine the anonymous key AK according to the long-term key K. Specifically, the random number generation unit 410 may further generate the first random number R1, and the authentication token generation unit 420 may determine the anonymous key AK according to the long-term key K and the first random number R1. For example, the authentication token generation unit 420 may determine the anonymous key AK according to the functional relationship fs between the anonymous key AK and the first random number R1 and the long-term key K. That is, the authentication token generation unit 420 may determine the anonymous key AK by the equation (2) described above.

According to the embodiment of the present disclosure, the authentication token generation unit 420 may determine the hidden value CONC of the second random number according to the second random number R2 and the anonymous key AK. Specifically, the authentication token generation unit 420 may determine the hidden value CONC of the second random number by performing XOR operation on the second random number R2 and the anonymous key AK. That is, the authentication token generation unit 420 may determine the hidden value CONC of the second random number by the equation (10):

$$CONC = R 2 ⊕ AK \qquad ( 10 )$$

According to the embodiment of the present disclosure, the authentication token generation unit 420 may determine the home network AUTN according to the hidden value CONC of the second random number. For example, the authentication token generation unit 420 may determine the hidden value CONC of the second random number as a part of the home network AUTN.

According to the embodiment of the present disclosure, the authentication token generation unit 420 may determine the HNMAC according to the long-term key K. Specifically, the authentication token generation unit 420 may determine the HNMAC according to the first random number R1 and the long-term key K. For example, the authentication token generation unit 420 may determine the HNMAC according to the functional relationship f₁ between the HNMAC and the long-term key K and the first random number R1. That is, the authentication token generation unit 420 may determine the HNMAC by the equation (11):

$$HNMAC = {f}_{1} ( K , R 1 ) \qquad ( 11 )$$

According to the embodiment of the present disclosure, the authentication token generation unit 420 may determine the home network AUTN according to the HNMAC. For example, the authentication token generation unit 420 may determine the HNMAC as another part of the home network AUTN.

That is, the authentication token generation unit 420 may determine the home network AUTN according to the HNMAC and the hidden value CONC of the second random number. Specifically, the authentication token generation unit 420 may perform a string concatenation operation on the hidden value CONC of the second random number and the HNMAC to determine the home network AUTN.

According to the embodiment of the present disclosure, the electronic device 400 may transmit the home network AUTN generated by the authentication token generation unit 420 to the SN for the SN to forward the home network AUTN to the user equipment, so that the user equipment can restore the R2 from the home network AUTN, thereby authenticating the SN. The electronic device 400 may further transmit the second random number R2 generated by the random number generation unit 410 to the SN for the SN to generate the SNMAC and transmit the SNMAC to the user equipment, so that the user equipment can authenticate the SN by using the SNMAC. The electronic device 400 may further transmit the first random number R1 generated by the random number generation unit 410 to the SN for the SN to authenticate the user equipment by using the first random number R1, and the SN may further transmit the first random number R1 to the user equipment for the user equipment to authenticate the SN and the HN.

As described above, the user equipment can authenticate the SN in an explicit manner with the assistance of the electronic device 400.

According to the embodiment of the present disclosure, as shown in FIG. 4, the electronic device 400 may further include a security anchor key generation unit 450. The security anchor key generation unit 450 is configured to determine a security anchor key K_{SERF} according to the first random number R1 generated by the random number generation unit 410, the long-term key K between the user equipment and the electronic device 400 from the storage unit 440, and the identification information of the SN for communication between the user equipment and the SN.

According to the embodiment of the present disclosure, the electronic device 400 may acquire identification information SNname of the SN via the communication unit 430 from the SN, such as the core network of the SN. Furthermore, the security anchor key generation unit 450 may generate the security anchor key K_{SEAF} according to the R1, K, and the identification information of the SN through KDF. That is, the security anchor key generation unit 450 may generate the security anchor key K_{SEAF} by the equation (6) described above.

According to the embodiment of the present disclosure, the electronic device 400 may further transmit, via the communication unit 430, the security anchor key generated by the security anchor key generation unit 450, to the SN, such as the core network of the SN for communication between the SN and the user equipment.

According to the embodiment of the present disclosure, as shown in FIG. 4, the electronic device 400 may further include a reference value generation unit 460. The reference value generation unit 460 is configured to determine the reference value HXRES* of the response value according to the first random number R1 generated by the random number generation unit 410, the long-term key K between the user equipment and the electronic device 400 from the storage unit 440, and the identification information of the SN.

Specifically, the reference value generation unit 460 may determine an expected response value XRES* according to the first random number R1, the long-term key K, and the identification information of the SN. The expected response value represents the expected response value generated by the user equipment. For example, the reference value generation unit 460 may determine the expected response value XRES* according to the functional relationship f₂ between the expected response value XRES* and the long-term key K, the first random number R1, and the identification information (SNname) of the SN. That is, the reference value generation unit 460 may determine the expected response value XRES* by the equation (12):

$${XRES}^{*} = {f}_{2} ( K , R 1 , SNname ) \qquad ( 12 )$$

According to the embodiment of the present disclosure, the reference value generation unit 460 may determine the reference value HXRES* of the response value according to the expected response value XRES* and the first random number R1. Specifically, the reference value generation unit 460 may determine the reference value HXRES* of the response value by concatenating the first random number R1 and the expected response value XRES* and then performing hash operation. That is, the reference value generation unit 460 may determine the reference value HXRES* of the response value by the following equation (13):

$${HXRES}^{*} = Hash ( 〈 R 1 , {XRES}^{*} 〉 ) \qquad ( 13 )$$

According to the embodiment of the present disclosure, the electronic device 400 may transmit the reference value HXRES* of the response value to the SN via the communication unit 430 for the SN to authenticate the user equipment.

It can be seen that the electronic device 400 according to the embodiment of the present disclosure may transmit the reference value HXRES* of the response value to the SN, so that the SN can authenticate the user equipment by using the reference value HXRES* of the response value. That is, the bidirectional authentication between the user equipment and the SN can be implemented with the assistance of the electronic device 400, thereby improving the network security.

According to the embodiment of the present disclosure, the electronic device 400 may receive, from the SN via the communication unit 430, the response value RES* generated by the user equipment. If the response value RES* generated by the user equipment is received by the electronic device 400 from the SN, it indicates that the SN successfully authenticates the user equipment.

According to the embodiment of the present disclosure, as shown in FIG. 4, the electronic device 400 may further include an authentication unit 470. The authentication unit 470 is configured to authenticate the user equipment. Here, the authentication unit 470 may authenticate the user equipment according to the response value RES* received from the SN and the expected response value XRES* generated by the reference value generation unit 460. For example, in a case that the response value RES* is consistent with the expected response value XRES*, the authentication unit 470 determines that the user equipment is authenticated successfully. In a case that the response value RES* is inconsistent with the expected response value XRES*, the authentication unit 470 determines that the user equipment is not authenticated successfully.

According to the embodiment of the present disclosure, in a case that the authentication unit 470 successfully authenticates the user equipment, the electronic device 400 may transmit a message indicating successful authentication to the SN via the communication unit 430. Furthermore, the electronic device 400 may further transmit the SUPI of the user equipment to the SN via the communication unit 430.

As described above, the electronic device 400 according to the embodiment of the present disclosure may generate the home network AUTN by using the second random number R2, so that the user equipment can authenticate the SN by using the second random number R2 obtained from the home network AUTN. In this way, the electronic device 400 and the user equipment are not required to save the SQN, thereby avoiding replay attack due to the loss of synchronization of the SQN. In addition, the user equipment can authenticate the SN in an explicit manner with the assistance of the electronic device 400. Compared with the implicit authentication, the explicit authentication can improve the network security. Furthermore, both the bidirectional authentication between the user equipment and the SN and the bidirectional authentication between the user equipment and the HN can be implemented with the assistance of the electronic device 400, thereby further improving the network security.

### 5. Signaling Flowchart

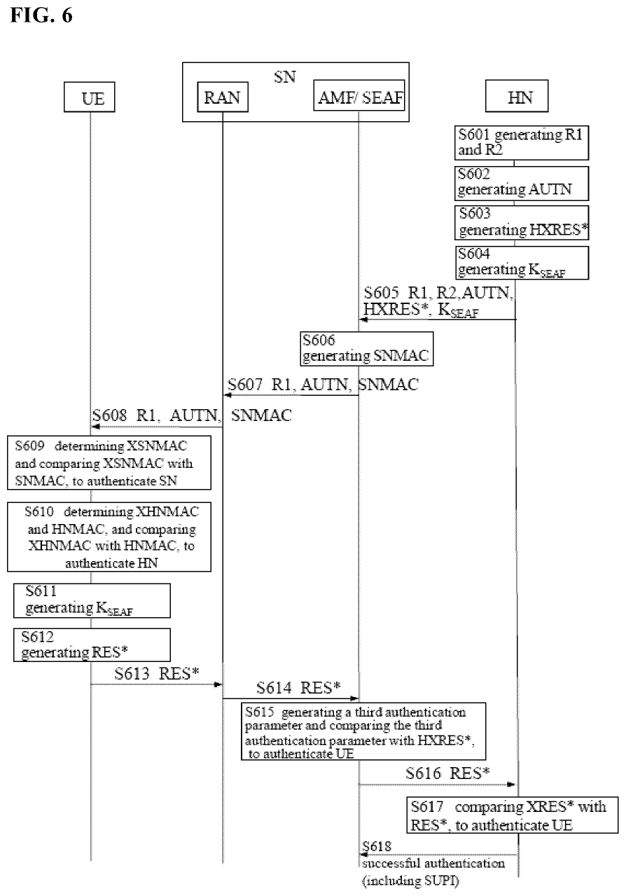

A signaling flowchart of an authentication method according to the present disclosure is described in conjunction with FIGS. 5 and 6. For ease of description, the authentication method according to the present disclosure is divided into two parts of an initialization process and an authentication process. In FIGS. 5 and 6, the UE may be implemented by the user equipment 200. AMF/SEAF in the SN may be implemented by the electronic device 300. RAN in the SN may include the base station device, and RAN in the SN may communicate with AMF/SEAF via an N2 interface. The HN may include the electronic device 400 in the core network. In addition, the UE and the HN share the long-term key K of the UE and the SUPI of the UE, and the UE is aware of the identification information SNname of the UE.

FIG. 5 is a signaling flowchart illustrating an initialization process of an authentication method according to an embodiment of the present disclosure. As shown in FIG. 5, in step S501, the UE and the base station device in the RAN generate the physical layer key Kp according to the wireless channel characteristics. In step S502, the UE transmits N1 message to the RAN, and the N1 message includes the SUCI of the UE. In step S503, the RAN transmits N2 message to AMF/SEAF, and the N2 message includes the SUCI of the UE and the physical layer key Kp. In step S504, the AMF/SEAF transmits N12 message (authentication initialization request message) to the HN, and the N12 message includes the SUCI of the UE and the identification information of the SN. As a result, the UE and the SN share the physical layer key Kp, and the HN acquires the identification information of the SN.

FIG. 6 is a signaling flowchart illustrating an initialization process of an authentication method according to an embodiment of the present disclosure. As shown in FIG. 6, in step S601, the HN generates the first random number R1 and the second random number R2. In step S602, the HN generates AUTN. For example, the HN may determine the anonymous key AK according to the long-term key K and the first random number R1 by the equation (2) described above, determine the hidden value CONC of the second random number R2 according to the second random number R2 and the anonymous key AK by the equation (10) described above, determine HNMAC according to the first random number R1 and the long-term key K by the equation (11) described above, and determine the home network AUTN according to the HNMAC and the hidden value CONC of the second random number. In step S603, the HN generates the reference value HXRES* of the response value. For example, the HN may determine the expected response value XRES* according to the first random number R1, the long-term key K, and the identification information of the SN by the equation (12) described above, determine the reference value HXRES* of the response value according to the expected response value XRES* and the first random number R1 by the equation (13) described above. In step S604, the HN generates the security anchor key K_{SEAF}. For example, the HN may determine the security anchor key K_{SERF} according to the first random number R1, the long-term key K, and the identification information of the SN by the equation (6) described above. In step S605, the HN transmits the generated first random number R1, the second random number R2, the home network AUTN, the reference value HXRES* of the response value, and the security anchor key K_{SEAF} to AMF/SEAF in the SN. For example, the HN may generate AV according to the above information and transmit the AV to the SN. In step S606, AMF/SEAF generates SNMAC. For example, the AMF/SEAF may determine the SNMAC according to the second random number R2 and the physical layer key Kp by the equation (8) described above. In step S607, AMF/SEAF transmits the first random number R1 from the HN, the home network AUTN from the HN, and the generated SNMAC to RAN. In step S608, the RAN forwards the first random number R1, the home network AUTN, and the SNMAC to the UE. For example, the RAN may transmit the above information to the UE through the AV. In step S609, UE determines an authentication parameter XSNMAC. For example, UE may decompose CONC from the home network AUTN by the equation (1) described above, determine the anonymous key AK according to the first random number R1 and the long-term key K by the equation (2) described above, determine the second random number R2 according to the anonymous key AK and the hidden value CONC of the second random number, and determine a value of the authentication parameter XSNMAC according to the physical layer key Kp and the second random number R2 by the equation (4) described above. In addition, in step S609, the UE further authenticates the SN by comparing the generated XSNMAC with the received SNMAC. In step S610, UE determines the second authentication parameter XHNMAC and HNMAC. For example, UE may decompose the HNMAC from the home network AUTN by the equation (1) described above, and determine the second authentication parameter XHNMAC according to the long-term key K and the first random number R1 received from the SN by the equation (5) described above. In addition, in step S610, UE authenticates the HN by comparing the XHNMAC and the HNMAC. In a case that UE authenticates successfully the HN and the SN, in step S611, UE generates the security anchor key K_{SEAF}. For example, UE may determine the security anchor key K_{SERF} according to the first random number R1, the long-term key K, and the identification information of the SN by the equation (6) described above. In step S612, UE generates a response value RES*. For example, UE determines the response value RES* according to the first random number R1, the long-term key K, and the identification information of the SN received from the SN by the equation (7) described above. In step S613, UE transmits the generated response value RES* to the RAN in the SN. In step S614, the RAN forwards the response value RES* to AMF/SEAF. In step S615, AMF/SEAF generates a third authentication parameter. For example, AMF/SEAF determines the third authentication parameter according to the first random number R1 and the response value RES* from the UE by the equation (9) described above. In addition, in step S615, AMF/SEAF also authenticates the UE by comparing the third authentication parameter with the reference value HXRES* of the response value from the HN. In step S616, in a case that UE is authenticated successfully in step S615, AMF/SEAF forwards the response value RES* of the UE to the HN. In step S617, HN authenticates the UE by comparing the received response value RES* with the generated expected response value XRES*. In step S618, in a case that UE is authenticated successfully in step S617, HN transmits a message indicating the successful authentication to the AMF/SEAF, including the SUPI of the UE. In this way, both the bidirectional authentication between the UE and the SN and the bidirectional authentication between the UE and the HN are implemented.

According to the embodiment of the present disclosure, in a case that UE is required to perform connection authentication, the initialization process shown in FIG. 5 and the authentication process shown in FIG. 6 may be performed. That is, the physical layer key Kp needs to be regenerated for each authentication. After the current successful authentication and before the next authentication, UE may be communicated with SN by using the key derived from the security anchor key K_{SEAF}. As shown in FIG. 6, UE authenticates SN in an explicit manner, and there is no need to use the SQN during the authentication process due to the introduction of the second random number R2.

### 6. Embodiments of Method

A wireless communication method performed by the user equipment 200 according to an embodiment of the present disclosure is described in detail below.

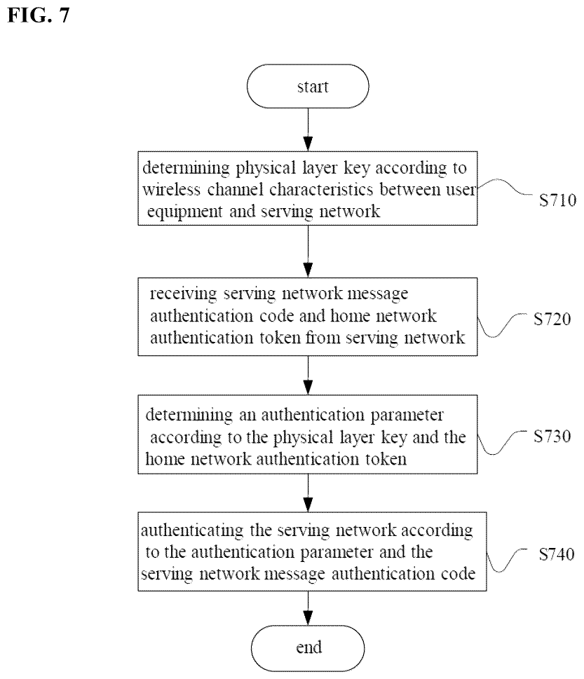

FIG. 7 is a flowchart of a wireless communication method performed by the user equipment 200 according to an embodiment of the present disclosure.

As shown in FIG. 7, in step S710, the physical layer key is determined according to the wireless channel characteristics between the user equipment 200 and the serving network.

In step S720, the serving network message authentication code and the home network authentication token are received from the serving network.

In step S730, the authentication parameter is determined according to the physical layer key and the home network authentication token.

In step S740, the serving network is authenticated according to the authentication parameter and the serving network message authentication code.

Preferably, the step of determining the authentication parameter includes determining the second random number generated by the home network according to the home network authentication token, and determining the authentication parameter according to the physical layer key and the second random number.

Preferably, the step of determining the second random number includes determining the hidden value of the second random number according to the home network authentication token, determining the anonymous key according to the long-term key between the user equipment and the home network, and determining the second random number according to the anonymous key and the hidden value of the second random number.

Preferably, the wireless communication method further includes receiving a first random number from the serving network, and determining the anonymous key according to the first random number and the long-term key.

Preferably, the wireless communication method further includes determining the home network message authentication code according to the home network authentication token, determining the second authentication parameter according to the long-term key between the user equipment and the home network, and authenticating the home network according to the second authentication parameter and the home network message authentication code.

Preferably, the step of determining the second authentication parameter includes receiving the first random number from the serving network, and determining the second authentication parameter according to the first random number and the long-term key.

Preferably, the wireless communication method further includes receiving the first random number from the serving network, and determining the security anchor key according to the first random number, the long-term key between the user equipment and the home network, and the identification information of the serving network for communication between the user equipment and the serving network.

Preferably, the wireless communication method further includes receiving the first random number from the serving network, determining a response value according to the first random number, the long-term key between the user equipment and the home network, and the identification information of the serving network, and transmitting the response value to the serving network for the serving network to authenticate the user equipment.

According to the embodiment of the present disclosure, a subject that performs the above method may be the user equipment 200 according to the embodiment of the present disclosure. Therefore, the above embodiments of the user equipment 200 are applicable here.

Next, a wireless communication method performed by an electronic device 300 in the SN according to an embodiment of the present disclosure is described in detail below.

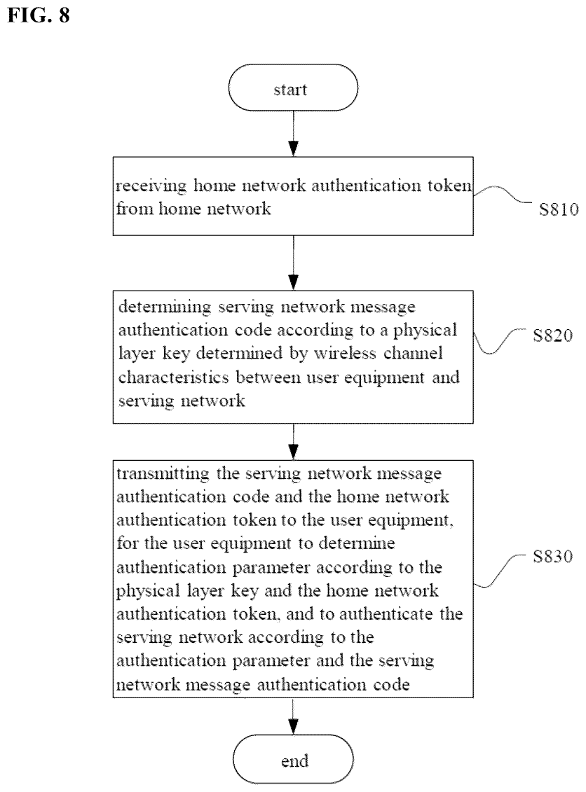

FIG. 8 is a flowchart of a wireless communication method performed by the electronic device 300 in a wireless communication system according to an embodiment of the present disclosure.

As shown in FIG. 8, in step S810, the home network authentication token is received from the home network.

In step S820, the serving network message authentication code is determined according to the physical layer key determined by the wireless channel characteristics between the user equipment and the serving network.

In step S830, the serving network message authentication code and the home network authentication token are transmitted to the user equipment for the user equipment to determine the authentication parameter according to the physical layer key and the home network authentication token, and to authenticate the serving network according to the authentication parameter and the serving network message authentication code.

Preferably, the wireless communication method further includes receiving the second random number from the home network, and determining the serving network message authentication code according to the second random number and the physical layer key.

Preferably, the wireless communication method further includes receiving the response value from the user equipment, determining the third authentication parameter according to the response value, receiving a reference value of the response value from the home network, and authenticating the user equipment according to the reference value of the third authentication parameter and the response value.

Preferably, the wireless communication method further includes receiving the first random number from the home network, and determining the third authentication parameter according to the first random number and the response value.

According to the embodiment of the present disclosure, a subject that performs the above method may be the user equipment 300 according to the embodiment of the present disclosure. Therefore, the above embodiments of the user equipment 300 are applicable here.

Next, a wireless communication method performed by an electronic device 400 in the HN according to an embodiment of the present disclosure is described in detail below.

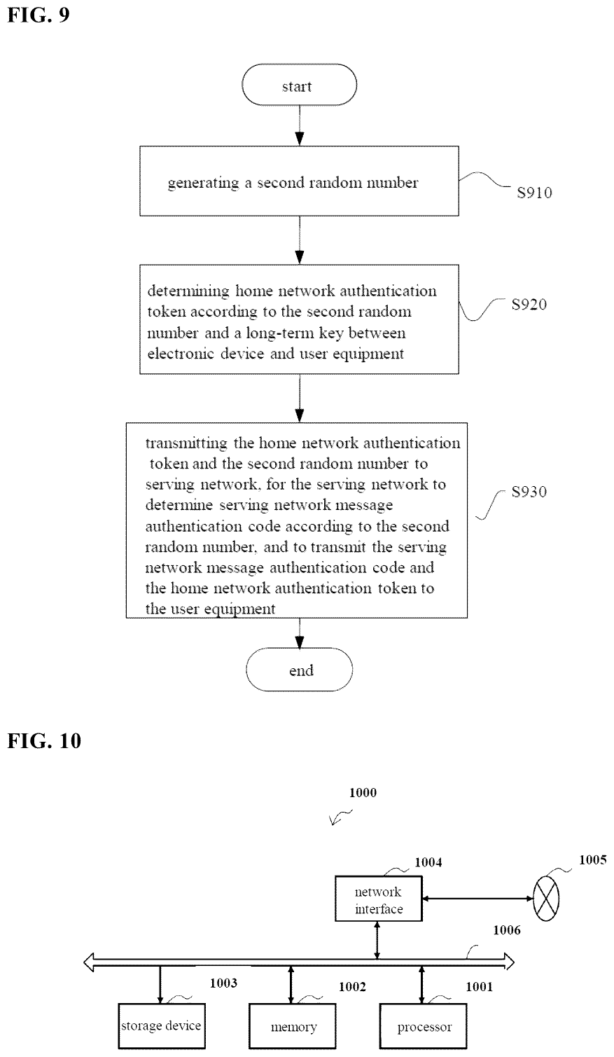

FIG. 9 is a flowchart of a wireless communication method performed by the electronic device 400 in a wireless communication system according to an embodiment of the present disclosure.

As shown in FIG. 9, in step S910, the second random number is generated.

In step S920, the home network authentication token is determined according to the second random number and the long-term key between the electronic device 400 and the user equipment.

In step S930, the home network authentication token and the second random number are transmitted to the serving network for the serving network to determine the serving network message authentication code according to the second random number, and to transmit the serving network message authentication code and the home network authentication token to the user equipment.

Preferably, the step of determining the home network authentication token includes determining an anonymous key according to the long-term key, determining the hidden value of the second random number according to the second random number and the anonymous key, and determining the home network authentication token according to the hidden value of the second random number.

Preferably, the step of determining the anonymous key includes generating a first random number, and determining the anonymous key according to the first random number and the long-term key.

Preferably, the step of determining the home network authentication token includes determining the home network message authentication code according to the long-term key, and determining the home network authentication token according to the home network message authentication code and the hidden value of the second random number.

Preferably, the step of determining the home network message authentication code includes generating the first random number, and determining the home network message authentication code according to the first random number and the long-term key.

Preferably, the wireless communication method further includes generating the first random number, and determining the security anchor key according to the first random number, the long-term key, and the identification information of the serving network for communication between the user equipment and the serving network.

Preferably, the wireless communication method further includes generating the first random number, determining the reference value of the response value according to the first random number, the long-term key, and the identification information of the serving network, and transmitting the reference value of the response value to the serving network for the serving network to authenticate the user equipment.

Preferably, the step of determining the reference value of the response value includes determining the expected response value according to the first random number, the long-term key, and the identification information of the serving network, and determining the reference value of the response value according to the expected response value and the first random number.

Preferably, the wireless communication method further includes receiving the response values generated by the user equipment from the serving network, and authenticating the user equipment according to the response value and the expected response value.

According to the embodiment of the present disclosure, a subject that performs the above method may be the electronic device 400 according to the embodiment of the present disclosure. Therefore, the above embodiments of the electronic device 400 are applicable here.

### 7. Application Examples

The technology of the present disclosure may be applied to various products.

For example, the electronic devices 300 and 400 each may be implemented as any type of servers, such as tower server, rack server or blade server. The electronic devices 300 and 400 may be a control module (such as an integrated circuitry module including a single die, and a card or blade inserted into a slot of a blade server) mounted on a server.

The user equipment 200 may be implemented as a mobile terminal (such as smartphone, tablet personal computer (PC), notebook PC, portable game terminal, portable/dongle type mobile router, and digital camera), or a vehicle-mounted terminal (such as car navigation apparatus). The user equipment may also be implemented as a terminal (also referred to as a machine-type communication (MTC) terminal) that performs machine-to-machine (M2M) communication. Furthermore, the user equipment may be a wireless communication module (such as an integrated circuitry module including a single die) mounted on each of the terminals described above.

### <Application Example Regarding Server>

FIG. 10 is a block diagram of an example of a server 1000 that can implement the electronic devices 300 and 400 according to the present disclosure. The server 1000 includes a processor 1001, a memory 1002, a storage device 1003, a network interface 1004, and a bus 1006.

The processor 1001 may be, for example, a central processing unit (CPU) or a digital signal processor (DSP), and controls functions of the server 1000. The memory 1002 includes random access memory (RAM) and read only memory (ROM), and stores data and a program that is executed by the processor 1001. The storage device 1003 may include a storage medium such as semiconductor memory and hard disc.

The network interface 1004 is a wired communication interface for connecting the server 1000 to a wired communication network 1005. The wired communication network 1005 may be a core network such as evolved packet core (EPC) network or a packet data network (PDN) such as the Internet.

The bus 1006 connects the processor 1001, the memory 1002, the storage device 1003 and the network interface 1004 to each other. The bus 1006 may include two or more buses (such as high-speed bus and low-speed bus), each of which has different speed.

In the server 1000 shown in FIG. 10, the generation unit 320 and the authentication unit 330 described in FIG. 3, the random number generation unit 410, authentication token generation unit 420, the security anchor key generation unit 450, the reference value generation unit 460, and the authentication unit 470 described in FIG. 4 may be implemented by the processor 1001, and the communication unit 310 described in FIG. 3 and the communication unit 430 described in FIG. 4 may be implemented by the network interface 1004. For example, the processor 1001 may execute instructions stored in the memory 1002 or the storage device 1003 to implement functions such as generating the serving network message authentication code, authenticating the user equipment, generating the random number, generating the home network authentication token, generating the security anchor key, generating the reference value of the response value, and authenticating the user equipment.

### <Application Example Regarding Terminal Device>

### First Application Example

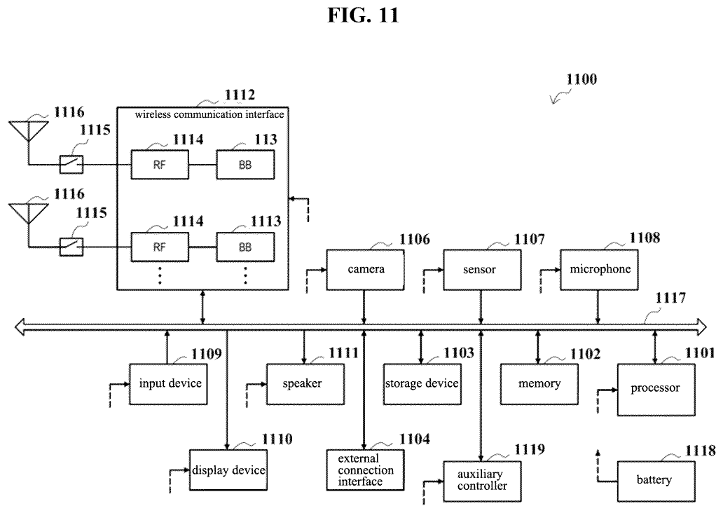

FIG. 11 is a block diagram showing an exemplary configuration of a smartphone 1100 to which the technology according to the present disclosure may be applied. The smartphone 1100 includes a processor 1101, a memory 1102, a storage device 1103, an external connection interface 1104, a camera 1106, a sensor 1107, a microphone 1108, an input device 1109, a display device 1110, a speaker 1111, a wireless communication interface 1112, one or more antenna switches 1115, one or more antennas 1116, a bus 1117, a battery 1118, and an auxiliary controller 1119.

The processor 1101 may be, for example, a CPU or a system on a chip (SoC), and controls functions of an application layer and another layer of the smartphone 1100. The memory 1102 includes a RAM and a ROM, and stores a program executed by the processor 1101 and data. The storage device 1103 may include a storage medium such as semiconductor memory and hard disk. The external connection interface 1104 is an interface for connecting an external device (such as memory card and universal serial bus (USB) device) to the smartphone 1100.

The camera 1106 includes an image sensor (such as charge coupled device (CCD) and complementary metal oxide semiconductor (CMOS)), and generates a captured image. The sensor 1107 may include a set of sensors, such as measurement sensor, gyro sensor, geomagnetism sensor, and acceleration sensor. The microphone 1108 converts sounds that are inputted to the smartphone 1100 to audio signals. The input device 1109 includes, for example, a touch sensor configured to detect touch onto a screen of the display device 1110, a keypad, a keyboard, a button, or a switch, and receives an operation or information inputted from a user. The display device 1110 includes a screen (such as liquid crystal display (LCD) and organic light-emitting diode (OLED) display), and displays an output image of the smartphone 1100. The speaker 1111 converts audio signals that are outputted from the smartphone 1100 to sounds.

The wireless communication interface 1112 supports any cellular communication scheme (such as LTE and LTE-advanced), and performs wireless communication. The wireless communication interface 1112 may include, for example, a BB processor 1113 and an RF circuit 1114. The BB processor 1113 may perform, for example, encoding/decoding, modulating/demodulating, and multiplexing/de-multiplexing, and perform various types of signal processing for wireless communication. The RF circuit 1114 may include, for example, a mixer, a filter and an amplifier, and transmits and receives wireless signals via the antenna 1116. The wireless communication interface 1112 may be a chip module having the BB processor 1113 and the RF circuit 1114 integrated thereon. As shown in FIG. 11, the wireless communication interface 1112 may include multiple BB processors 1113 and multiple RF circuits 1114. Although FIG. 11 shows the example in which the wireless communication interface 1112 includes the multiple BB processors 1113 and the multiple RF circuits 1114, the wireless communication interface 1112 may also include a single BB processor 1113 or a single RF circuit 1114.

Furthermore, in addition to a cellular communication scheme, the wireless communication interface 1112 may support another type of wireless communication scheme such as short-distance wireless communication scheme, near field communication scheme, and radio local area network (LAN) scheme. In this case, the wireless communication interface 1112 may include the BB processor 1113 and the RF circuit 1114 for each wireless communication scheme.

Each of the antenna switches 1115 switches connection destinations of the antennas 1116 among multiple circuits (such as circuits for different wireless communication schemes) included in the wireless communication interface 1112.

Each of the antennas 1116 includes a single or multiple antenna elements (such as multiple antenna elements included in an MIMO antenna) and is used for the wireless communication interface 1112 to transmit and receive wireless signals. As shown in FIG. 11, the smartphone 1100 may include the multiple antennas 1116. Although FIG. 11 shows the example in which the smartphone 1100 includes the multiple antennas 1116, the smartphone 1100 may also include a single antenna 1116.

Furthermore, the smartphone 1100 may include the antenna 1116 for each wireless communication scheme. In this case, the antenna switches 1115 may be omitted from the configuration of the smartphone 1100.

The bus 1117 connects the processor 1101, the memory 1102, the storage device 1103, the external connection interface 1104, the camera 1106, the sensor 1107, the microphone 1108, the input device 1109, the display device 1110, the speaker 1111, the wireless communication interface 1112, and the auxiliary controller 1119 to each other. The battery 1118 supplies power to blocks of the smart phone 1100 shown in FIG. 11 via feeder lines that are partially shown as dashed lines in FIG. 11. The auxiliary controller 1119, operates a minimum necessary function of the smart phone 1100, for example, in a sleep mode.

In the smartphone 1100 shown in FIG. 11, the physical layer key generation unit 210, the authentication unit 230, the security anchor key generation unit 250, and the response value generation unit 260 described in FIG. 2 may be implemented by the processor 1101 or the auxiliary controller 1119. At least a part of the functions may also be implemented by the processor 1101 or the auxiliary controller 1119. For example, the processor 1101 or the auxiliary controller 1119 may execute instructions stored in the memory 1102 or the storage device 1103 to implement functions such as generating the physical layer key, authenticating the serving network, authenticating the home network, generating the security anchor key, and generating the response value.

### Second Application Example

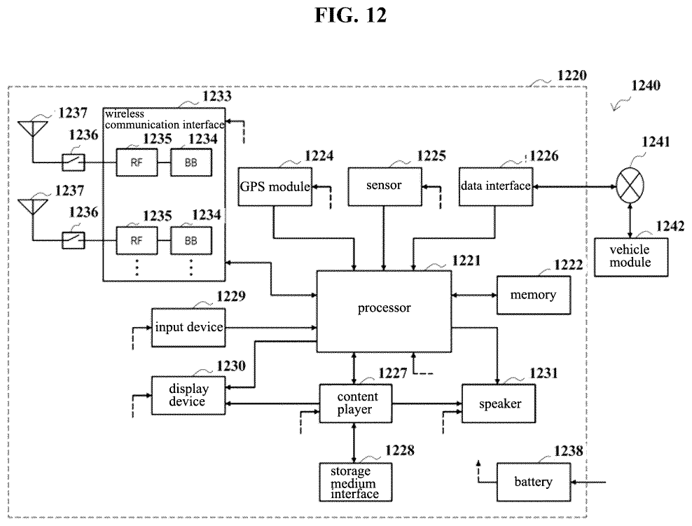

FIG. 12 is a block diagram showing an example of an exemplary configuration of a car navigation apparatus 1220 to which the technology according to the present disclosure may be applied. The car navigation apparatus 1220 includes a processor 1221, a memory 1222, a global positioning system (GPS) module 1224, a sensor 1225, a data interface 1226, a content player 1227, a storage medium interface 1228, an input device 1229, a display device 1230, a speaker 1231, a wireless communication interface 1233, one or more antenna switches 1236, one or more antennas 1237, and a battery 1238.

The processor 1221 may be, for example a CPU or a SoC, and controls a navigation function and additional function of the car navigation apparatus 1220. The memory 1222 includes RAM and ROM, and stores a program that is executed by the processor 1221 and data.

The GPS module 1224 determines a position (such as latitude, longitude and altitude) of the car navigation apparatus 1220 by using GPS signals received from a GPS satellite. The sensor 1225 may include a set of sensors such as gyro sensor, geomagnetic sensor and air pressure sensor. The data interface 1226 is connected to, for example, an vehicle-mounted network 1241 via a terminal that is not shown, and acquires data (such as vehicle speed data) generated by the vehicle.

The content player 1227 reproduces content stored in a storage medium (such as CD and DVD) that is inserted into the storage medium interface 1228. The input device 1229 includes, for example, a touch sensor configured to detect touch onto a screen of the display device 1230, a button, or a switch, and receives an operation or information inputted from a user. The display device 1230 includes a screen such as LCD or OLED display, and displays an image of the navigation function or content that is reproduced. The speaker 1231 outputs a sound for the navigation function or the content that is reproduced.

The wireless communication interface 1233 supports any cellular communication scheme (such as LTE and LTE-Advanced), and performs wireless communication. The wireless communication interface 1233 may typically include, for example, a BB processor 1234 and an RF circuit 1235. The BB processor 1234 may perform, for example, encoding/decoding, modulating/demodulating and multiplexing/demultiplexing, and perform various types of signal processing for wireless communication. The RF circuit 1235 may include for example a mixer, a filter and an amplifier, and transmits and receives wireless signals via the antenna 1237. The wireless communication interface 1233 may also be a chip module having the BB processor 1234 and the RF circuit 1235 integrated thereon. As shown in FIG. 12, the wireless communication interface 1233 may include multiple BB processors 1234 and multiple RF circuits 1235. Although FIG. 12 shows the example in which the wireless communication interface 1233 includes the multiple BB processors 1234 and the multiple RF circuits 1235, the wireless communication interface 1233 may also include a single BB processor 1234 and a single RF circuit 1235.

Furthermore, in addition to a cellular communication scheme, the wireless communication interface 1233 may support another type of wireless communication scheme such as short-distance wireless communication scheme, near field communication scheme, and wireless LAN scheme. In this case, the wireless communication interface 1233 may include the BB processor 1234 and the RF circuit 1235 for each wireless communication scheme.

Each of the antenna switches 1236 switches connection destinations of the antennas 1237 among multiple circuits (such as circuits for different wireless communication schemes) included in the wireless communication interface 1233.

Each of the antennas 1237 includes a single or multiple antenna elements (such as multiple antenna elements included in an MIMO antenna), and is used by the wireless communication interface 1233 to transmit and receive wireless signals. As shown in FIG. 12, the car navigation apparatus 1220 may include the multiple antennas 1237. Although FIG. 12 shows the example in which the car navigation apparatus 1220 includes the multiple antennas 1237, the car navigation apparatus 1220 may also include a single antenna 1237.

Furthermore, the car navigation apparatus 1220 may include the antenna 1237 for each wireless communication scheme. In this case, the antenna switches 1236 may be omitted from the configuration of the car navigation apparatus 1220.

The battery 1238 supplies power to the blocks of the car navigation apparatus 1220 shown in FIG. 12 via feeder lines that are partially shown as dash lines in FIG. 12. The battery 1238 accumulates power supplied from the vehicle.

In the car navigation apparatus 1220 shown in FIG. 12 the physical layer key generation unit 210, the authentication unit 230, the security anchor key generation unit 250, and the response value generation unit 260 described in FIG. 2 are implemented by the processor 1221. At least a part of functions may be implemented by the processor 1221. For example, the processor 1221 may execute instructions stored in the memory 1222 to implement functions such as generating the physical layer key, authenticating the serving network, authenticating the home network, generating the security anchor key, and generating the response value.

The technology of the present disclosure may also be implemented as an vehicle-mounted system (or a vehicle) 1240 including one or more blocks of the car navigation apparatus 1220, the vehicle-mounted network 1241 and a vehicle module 1242. The vehicle module 1242 generates vehicle data (such as vehicle speed, engine speed, and failure information), and outputs the generated data to the vehicle-mounted network 1241.

Preferred embodiments of the present disclosure have been described above with reference to the drawings, but the present disclosure is not limited to the above examples of course. Those skilled in the art may make various alternations and modifications within the scope of the claims. It should be understood that these alternations and modifications shall naturally fall within the technical scope of the present disclosure.

For example, units indicated by a dotted line block in the functional block diagram shown in the drawings indicate that the functional units are optional in the corresponding device, and the optional functional units may be combined appropriately to implement required functions.

For example, multiple functions implemented by one unit in the above embodiments may be implemented by separate devices. Alternatively, multiple functions implemented by multiple units in the above embodiments may be implemented by separate devices, respectively. Furthermore, one of the above functions may be implemented by multiple units. These configurations are naturally included in the technical scope of the present disclosure.

In the specification, steps described in the flowchart include not only the processes performed in chronological order as described, but also the processes performed in parallel or individually. Furthermore, the steps performed in chronological order may be performed in a different order.

The embodiments of the present disclosure have been described above in detail in conjunction with the drawings. However, it should be understood that the embodiments described above are intended to explain the present disclosure rather than limit the present disclosure. Those skilled in the art may make various modifications and alternations to the embodiments without departing from the essence and scope of the present disclosure. Therefore, the scope of the present disclosure is defined by the claims and equivalents thereof.

1. User equipment, comprising:
at least one processor; and
at least one memory including computer program code, wherein the at least one memory and the computer program code are configured, with the at least one processor, to cause the user equipment to at least:
determine a physical layer key according to wireless channel characteristics between the user equipment and a serving network;
receive a serving network message authentication code and a home network authentication token from the serving network;
determine an authentication parameter according to the physical layer key and the home network authentication token; and
authenticate the serving network according to the authentication parameter and the serving network message authentication code.

2. The user equipment according to claim 1, wherein the at least one memory and the computer program code are configured, with the at least one processor, to cause the user equipment further to:
determine a second random number generated by a home network according to the home network authentication token; and
determine the authentication parameter according to the physical layer key and the second random number.

3. The user equipment according to claim 2, wherein the at least one memory and the computer program code are configured, with the at least one processor, to cause the user equipment further to:
determine a hidden value of the second random number according to the home network authentication token;
determine an anonymity key according to a long-term key between the user equipment and the home network; and
determine the second random number according to the anonymity key and the hidden value of the second random number.

4. The user equipment according to claim 3, wherein the at least one memory and the computer program code are configured, with the at least one processor, to cause the user equipment further to:
receive a first random number from the serving network; and
determine the anonymity key according to the first random number and the long-term key.

5. The user equipment according to claim 1, wherein the at least one memory and the computer program code are configured, with the at least one processor, to cause the user equipment further to:
determine a home network message authentication code according to the home network authentication token;
determine a second authentication parameter according to a long-term key between the user equipment and the home network; and
authenticate the home network according to the second authentication parameter and the home network message authentication code.

6. The user equipment according to claim 5, wherein the at least one memory and the computer program code are configured, with the at least one processor, to cause the user equipment further to:
receive a first random number from the serving network; and
determine the second authentication parameter according to the first random number and the long-term key.

7. The user equipment according to claim 1, wherein the at least one memory and the computer program code are configured, with the at least one processor, to cause the user equipment further to:
receive a first random number from the serving network; and
determine, according to the first random number, a long-term key between the user equipment and the home network, and identification information of the serving network, a security anchor key for communication between the user equipment and the serving network.

8. The user equipment according to claim 1, wherein the at least one memory and the computer program code are configured, with the at least one processor, to cause the user equipment further to:
receive a first random number from the serving network; and
determine a response value according to the first random number, a long-term key between the user equipment and the home network, and identification information of the serving network; and
transmit the response value to the serving network for the serving network to authenticate the user equipment.

9. An electronic device in a serving network, comprising:
at least one processor; and
at least one memory including computer program code, wherein the at least one memory and the computer program code are configured, with the at least one processor, to cause the electronic device to at least:
receive a home network authentication token from a home network;
determine a serving network message authentication code according to a physical layer key determined from wireless channel characteristics between user equipment and the serving network; and
transmit the serving network message authentication code and the home network authentication token to the user equipment, for the user equipment to determine an authentication parameter according to the physical layer key and the home network authentication token, and to authenticate the serving network according to the authentication parameter and the serving network message authentication code.

10. The electronic device according to claim 9, wherein the at least one memory and the computer program code are configured, with the at least one processor, to cause the electronic device further to:
receive a second random number from the home network; and
determine the serving network message authentication code according to the second random number and the physical layer key.

11. The electronic device according to claim 9, wherein the at least one memory and the computer program code are configured, with the at least one processor, to cause the electronic device further to:
receive a response value from the user equipment;
determine a third authentication parameter according to the response value;
receive a reference value of the response value from the home network; and
authenticate the user equipment according to the third authentication parameter and the reference value of the response value.

12. The electronic device according to claim 11, wherein the at least one memory and the computer program code are configured, with the at least one processor, to cause the electronic device further to:
receive a first random number from the home network; and
determine the third authentication parameter according to the first random number and the response value.

13. An electronic device in a home network, comprising:
at least one processor; and
at least one memory including computer program code, wherein the at least one memory and the computer program code are configured, with the at least one processor, to cause the electronic device to at least:
generate a second random number;
determine a home network authentication token according to a long-term key between the electronic device and user equipment and the second random number; and
transmit the home network authentication token and the second random number to a serving network, for the serving network to determine a serving network message authentication code according to the second random number, and to transmit the serving network message authentication code and the home network authentication token to the user equipment.

14. The electronic device according to claim 13, wherein the at least one memory and the computer program code are configured, with the at least one processor, to cause the electronic device further to:
determine an anonymous key according to the long-term key;
determine a hidden value of the second random number according to the second random number and the anonymous key; and
determine the home network authentication token according to the hidden value of the second random number.

15. The electronic device according to claim 14, wherein the at least one memory and the computer program code are configured, with the at least one processor, to cause the electronic device further to:
generate a first random number; and
determine the anonymous key according to the first random number and the long-term key.

16. The electronic device according to claim 14, wherein the at least one memory and the computer program code are configured, with the at least one processor, to cause the electronic device further to:
determine a home network message authentication code according to the long-term key; and
determine the home network authentication token according to the home network message authentication code and the hidden value of the second random number.

17. The electronic device according to claim 16, wherein the at least one memory and the computer program code are configured, with the at least one processor, to cause the electronic device further to:
generate a first random number; and
determine the home network message authentication code according to the first random number and the long-term key.

18. The electronic device according to claim 13, wherein the at least one memory and the computer program code are configured, with the at least one processor, to cause the electronic device further to:
generate a first random number; and
determine, according to the first random number, the long-term key, and identification information of the serving network, a security anchor key for communication between the user equipment and the serving network.

19. The electronic device according to claim 13, wherein the at least one memory and the computer program code are configured, with the at least one processor, to cause the electronic device further to:
generate a first random number; and
determine a reference value of a response value according to the first random number, the long-term key, and identification information of the serving network; and
transmit the reference value of the response value to the serving network for the serving network to authenticate the user equipment.

20. The electronic device according to claim 19, wherein the at least one memory and the computer program code are configured, with the at least one processor, to cause the electronic device further to:
determine an expected response value according to the first random number, the long-term key, and the identification information of the serving network;
determine the reference value of the response value according to the expected response value and the first random number;
receive, from the serving network, a response value generated by the user equipment and
authenticate the user equipment according to the response value and the expected response value.

21.-43. (canceled)
